(19) United States
(12) Patent Application Publication
(10) Pub. No.: US 2002/0190432 A1
(43) Pub. Date: Dec. 19, 2002

(54) Liquid-crystalline polymer composition and molding method

(76) Inventors: Toshio Shiwaku, Shizuoka (JP); Takayuki Miyashita, Shizuoka (JP)

Correspondence Address: BURNS DOANE SWECKER & MATHIS L L P, POST OFFICE BOX 1404, ALEXANDRIA, VA, 22313-1404, US

(21) Appl. No.: 10/110,735

(22) PCT Filed: Mar. 13, 2001
(86) PCT No.: PCT/JP01/01943

(30) Foreign Application Priority Data
Mar. 14, 2000 (JP) 2000-70210

(51) Int. Cl. B29C 45/00; C09K 19/52

(52) U.S. Cl. 264/328.1; 252/299.01

(57) ABSTRACT

To provide liquid crystal polymer materials superior in shortening the molding time, which are suitable for connectors, electronic appliances, etc. That is, a liquid crystal polymer composition including (A) from 90 to 50% by weight of a liquid crystal polymer made of a specified aromatic polyester and (B) from 10 to 50% by weight of a liquid crystal polymer made of a specified aromatic polyester amide.

### TECHNICAL FIELD TO WHICH THE INVENTION BELONGS

The present invention concerns a liquid crystal polymer composition which comprises two kinds of liquid crystal polymers and, more in particular, it relates to a liquid crystal polymer composition capable of shortening a molding time used for a connector, etc. requiring high productivity.

Prior Art

Liquid crystal polymers capable of forming an anisotropic molten phase have been known as a material excellent in dimensional accuracy, heat resistance, mechanical properties and fluidity and hardly causing flash during molding among thermoplastic resins. Heretofore, glass fiber-reinforced liquid crystal polymer compositions have been adopted frequently as electronic parts while taking the advantage of the features described above. However, the weight, thickness and size in electronic parts have been decreased more and more in recent years, the molding processing cost has been increased more than the material cost in the cost of a molded article and it is necessary to shorten the molding time in order to reduce the cost for a molded article.

Heretofore, with an aim of further improving the properties of the liquid crystal polymer described above, an attempt of blending two or more kinds of liquid crystal polymers has been conducted. For example, it has been tried to improve the mechanical property and the fluidity by blending a wholly aromatic polyester and a melt processable polyester amide in JP-A 61-120851, or by blending a liquid crystal polyester amide and a liquid crystal polyester amide and/or liquid crystal polyester in JP-A 2-145643, respectively. While the mechanical property and the fluidity can be improved by the method described above, it is not sufficient for the improvement of the solidifying speed attributable to the shortening of the molding time and for the physical property such as rigidity at high temperature, and a material capable of overcoming the problem of shortening the molding time has not yet been present.

### DISCLOSURE OF THE INVENTION

In view of the foregoing problems, the present inventors have made an earnest study on the material having excellent properties in view of shortening the molding time and found that the molding time can be shortened by blending a wholly aromatic liquid crystal polyester (A) and a wholly aromatic liquid crystal polyester amide at a specified blending amount and have accomplished the invention.

That is, the present invention provides a liquid crystal polymer composition capable of shortening the molding time, which comprises 90 to 50% by weight of a liquid crystal polymer (A) having the following structural unit (I) or [(I)+(II)+(III)] and 10 to 50% by weight of a liquid crystal polymer (B) having the structural unit [(I′)+(II′)+(III′)+(IV)].

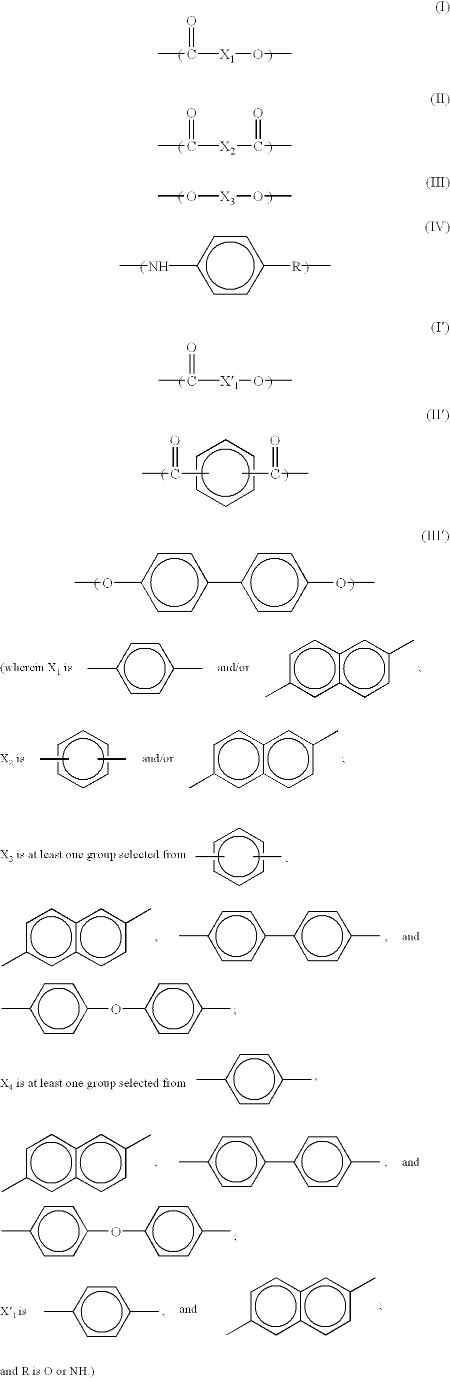

### DETAILED DESCRIPTION OF THE INVENTION

The present invention is to be explained more in details. The liquid crystal polymers (A) and (B) used in the invention means melting processable polymer having a property capable of forming an optical isotropic molten phase. The property of the anisotropic molten phase can be confirmed by an customary polarized light inspection method utilizing an orthogonal polarizer. More specifically, the anisotropic molten phase can be confirmed by using a Leitz polarization microscope and observing a molten specimen placed on a Leitz hot stage at 40× magnification in a nitrogen atmosphere. When inspected utilizing the orthogonal polarizer, the liquid crystal polymer applicable to this invention usually transmits polarized light even in a stationary molten state to show optical anisotropy.

Preferably, an aromatic polyester is preferred for the liquid crystal polymer (A) and an aromatic polyester amide is preferred for the liquid crystal polymer (B). Those having a logarithmic viscosity (I.V.) of at least about 2.0 dl/g and, further preferably, 2.0 to 10.0 dl/g when dissolved at a concentration of 0.1% by weight in pentafluorophenol at 60° C. are used.

The aromatic polyester as the liquid crystal polymer (A) applicable to this invention is preferably an aromatic polyester having at least one compound selected from the group consisting of aromatic hydroxy carboxylic acids, aromatic dicarboxylic acids and aromatic diols as the constituent.

More specifically, they can include:

(1) a polyester mainly comprising at least one of an aromatic hydroxycarboxylic acid and derivatives thereof;

(2) a polyester mainly comprising (a) at least one of an aromatic hydroxy carboxylic acid and derivatives thereof, (b) at least one of an aromatic dicarboxylic acid and derivatives thereof and (c) at least one of an aromatic diol and derivatives thereof. Further, a molecular weight controller such as terephthalic acid may also be used optionally in combination with the constituent described above. Combined use of the molecular weight controller is preferred, particularly, in a case where the component of the p-hydroxy benzoic acid is much contained because the reaction rate is high.

Further, the aromatic polyester amide as the liquid crystal polymer (B) applicable to this invention is, particularly preferably, an aromatic polyester amide having a compound selected from at least each one of aromatic hydroxycarboxylic acids, aromatic dicarboxylic acids and aromatic diols and p-aminophenol and/or p-phenylene diamine as the constituent.

More specifically, this is a polyester amide mainly comprising (a) at least one of an aromatic hydrocarboxylic acid and derivatives thereof, (b) at least one of an aromatic dicarboxylic acid and derivatives thereof, (c) at least one of an aromatic diol and derivatives thereof and (d) at least one member selected from the group consisting of p-aminophenol, p-phenylene diamine and derivatives thereof. Further, a molecular weight controller may also be used optionally in combination with the constituent described above.

Preferred examples of the specific compounds constituting the liquid crystal polymers (A) and (B) applicable to this invention can include aromatic hydroxycarboxylic acids such as p-hydroxybenzoic acid and 6-hydroxy-2-naphthoic acid; aromatic diols such as 2,6-dihydroxynaphthalene 1,4-dihydroxynaphthalene, 4,4′-dihydroxybiphenyl, hydroquinone and resorcine; aromatic dicarboxylic acids such as terephthalic acid, isophthalic acid, 4,4′,-diphenyl dicarboxylic acid and 2,6-naphthalene dicarboxylic acid; and aromatic amides such as p-aminophenol and p-phenylene diamine.

Particularly preferred liquid crystal polymer (A) applicable to this invention is-an aromatic polyester comprising p-hydroxybenzoic acid and 6-hydroxy-2-naphthoic acid as the main constituent unit and using terephthalic acid as the molecular weight controller. Further, a particularly preferred liquid crystal polymer (B) applicable to this invention is an aromatic polyester amide comprising p-hydroxybenzoic acid, 6-hydroxy-2-naphthoic acid, biphenol, terephthalic acid and p-aminophenol as the main constituent unit.

For attaining the object of this invention of shortening the molding time, it is preferred to incorporate a liquid crystal polymer composition comprising the liquid crystal polymer (A) and the liquid crystal polymer (B) with the fibrous filler (C). Incorporation of the fibrous filler (C) can improve the rigidity at high temperature and shorten the mold releasing time.

The fibrous filler (C) usable in this invention can include various kinds of organic fibers such as glass fibers, carbon milled glass fibers, wollastonite, whiskers, metal fibers, inorganic fibers and mineral type fibers.

As carbon fiber, PAN type fibers comprising polyacrylonitrile as the raw material and the pitch type fibers comprising pitch as the raw material are used.

For the whiskers, silicon nitride whisker, silicon trinitride whisker, basic magnesium sulfate whisker, barium titanate whisker, silicon carbide whisker and boron whisker maybe used and as metal fibers, fibers of soft steel, stainless steel, steel and alloys thereof, brass, aluminum and alloys thereof and lead can be used.

The inorganic type fibers usable include various fibers such as those of rockwool, zirconia, alumina silica, potassium titanate, barium titanate, silicon carbide, alumina, silica and blast furnace slag.

As the mineral type fibers, asbesto and wollastonite are used.

Among them, glass fibers are preferred in view of the performance.

As the glass fibers, usual glass fibers, as well as glass fibers coated with metal such as nickel or copper, or silane fibers can be used.

Referring to the addition amount of the fibrous filler for attaining the shortening of the molding time, when the addition amount is excessive, it worsens the extrudability and the moldability and, on the other hand, when the addition amount is insufficient, it deteriorates the mechanical strength. Therefore, the addition amount of the fibrous filler is from 1 to 150 parts by weight, preferably, 10 to 100 parts by weight based on 100 parts by weight of the total weight of the liquid crystal polymer composition comprising the liquid crystal polymer (A) and the liquid crystal polymer (B).

Further, non-fibrous filler may also be added within such a range as not hindering the shortening of the molding time. The non-fibrous filler means herein those of disk-like, square plate-like, rectangular or amorphous type not having extension to a predetermined direction.

The non-fibrous filler include, specifically, talc, mica, kaolin, clay, vermiculite, silicates such as calcium silicate, aluminum silicate and feldspar powder, acidic white clay, agalmatolite clay, sericite, sillimanite, bentonite, glass flake, slate flake and silane, carbonates such as calcium carbonate, chalk, barium carbonate, magnesium carbonate and dolomite, sulfate such as barite powder, blanc fixe, precipitating calcium sulfate, baked gypsum and barium sulfate, hydroxides such as alumina hydrate, oxides such as alumina, antimony oxide, magnesia, titania, zinc powder, silica, silicic sand, quartz, white carbon and diatomaceous earth, sulfides such as molybdenum disulfide, and substances containing materials such as metal particulate.

The fibrous filler and the non-fibrous filler may be used as they are, but known surface treating agents or binders agent used generally may be used in combination.

Further, compositions provided with desired properties by adding additives such as nucleating agent, carbon black, pigment such as inorganic baked pigment, antioxidant, stabilizer, plasticizer, lubricant, mold releasing agent and combustion agent to the liquid crystal polymer composition are also included within a range of the liquid crystal polymer composition referred to in the present invention.

In the liquid crystal polymer composition according to this invention, a material excellent in shortening the molding time is obtained by using two kinds of liquid crystal polymers to compensate drawbacks of them to each other thereby improving the mechanical property at high temperature. Further, a higher performance can be provided in a state of dispersion where two kinds of the liquid crystal polymers are uniformly dispersed in the molded article.

For producing such a liquid crystal polymer composition, both of them may be blended and extruded in the compositional ratio as descried above. Usually, they are extruded into pellets with an extruder and used in injection molding or the like, but it is not restricted only to the production with an extruder.

According to the liquid crystal polymer composition of the present invention, injection molding is possible within 1.5 sec of molding cycle.

### EXAMPLE

This invention is to be explained specifically by way of examples, but the invention is not restricted to them.

### Examples 1-2, Comparative Examples 1-3

Vectra A (manufactured by Polyplastics Co., Ltd.) as the liquid crystal polymer (A), Vectra B (manufactured by Polyplastics Co., Ltd.) as the liquid crystal polymer (B) were mixed in the compositions shown in Table 1, and extruded to prepare pellets by using a twin extruder (PCM-30 model, by Ikegai Iron Works, Ltd.). Then, they were molded into a connector shape by an injection molding machine (Roboshot α-30 iA manufactured by Fanuc, Ltd.) at the injection rate of 200 mm/s for the injection time of 0.1 s, and evaluation was made for the deformation of the molded articles at molding times of 1.00 sec and 1.10 sec. The results are shown in Table 1.

The liquid crystal polymer used in the examples have the following constituent units.

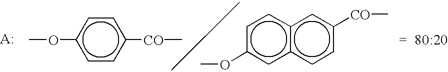

Terephthalic acid was used by 1.0 mol% as the molecular weight controller.

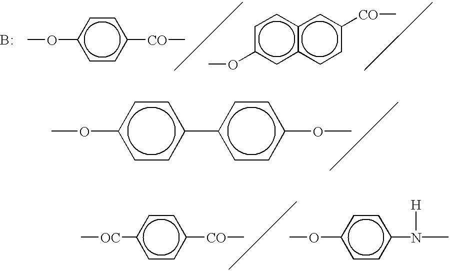

=60:5.0:12.5:17.5:5.0

TABLE 1

| | Liquid crystal | Liquid crystal | Fibrous | Molding time | |
|---|---|---|---|---|---|
| | polymer A | polymer B | filler (GF) | (sec) | |
| | (wt %) | (wt %) | (wt %) | 1.00 | 1.10 |
| Example 1 | 45 | 15 | 40 | ∘ | ∘ |
| Example 2 | 30 | 30 | 40 | Δ | Δ |
| Comp. | 60 | 0 | 40 | x | x |
| Example 1 | | | | | |
| Comp. | 15 | 45 | 40 | x | x |
| Example 2 | | | | | |
| Comp. | 0 | 60 | 40 | x | x |
| Example 3 | | | | | |

(note)
∘: no trace of ejector pin
Δ: slight traces of ejector pin
x: traces of ejector pin
GF: chopped glass fiber

1. A liquid crystal polymer composition capable of shortening the molding time, which comprises 90 to 50% by weight of a liquid crystal polymer (A) having the following structural unit (I) or {(I)+(II)+(III)} 10 to 50% by unit {(I′)+(II′)+(III′)+(IV)}:

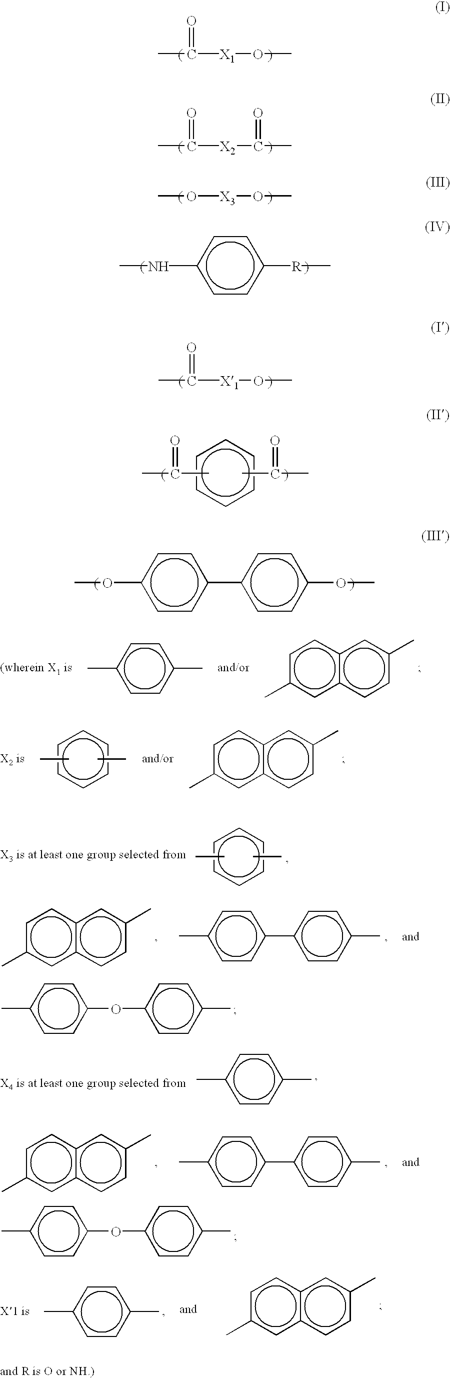

2. The composition according to claim 1, wherein X₁ in the structural unit (I) of the liquid crystal polymer (A) essentially contains the following group:

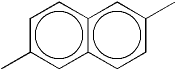

3. The composition according to claim 1 or 2, wherein the liquid crystal polymer (A) comprises the structural unit (I).

4. The composition according to claim 1, further comprising 1 to 150 parts by weight of a fibrous filler (C), based on 100 parts by weight of the total weight of the liquid crystal polymer composition comprising the liquid crystal polymer (A) and the liquid crystal polymer (B).

5. The composition according to claim 4, wherein the f ibrous filler (C) is a glass fiber.

6. A molding method comprising subjecting the liquid crystal polymer composition according to claim 1 to injection molding within a molding cycle of 1.5 seconds.
